(19) United States
(12) Patent Application Publication
(10) Pub. No.: US 2004/0074538 A1
(43) Pub. Date: Apr. 22, 2004

(54) Pressure management apparatus and methods

(76) Inventors: Vernon D. Ortenzi, Burlington, KY (US); James E. Kesterman, Cincinnati, OH (US); Timothy M. Hughes, Lake Forest, CA (US); James C. Gilbert, Maysville, KY (US)

Correspondence Address: DINSMORE & SHOHL, LLP, 1900 CHEMED CENTER, 255 EAST FIFTH STREET, CINCINNATI, OH, 45202, US

(21) Appl. No.: 10/685,948

(22) Filed: Oct. 15, 2003

Related U.S. Application Data
(60) Provisional application No. 60/418,398, filed on Oct. 15, 2002.

(51) Int. Cl. F16K 17/26

(52) U.S. Cl. 137/493.4; 137/549

(57) ABSTRACT

Pressure management apparatus are provided herein for coupling to an end of a vent pipe of a storage tank. Exemplary pressure management apparatus include a removable filter adapted to minimize and/or prevent debris from traveling from an interior of a storage tank to an interior of a housing of the pressure management apparatus. Further exemplary pressure management apparatus include a pressure valve with a high pressure valve portion and a low pressure valve portion. Methods of providing a pressure management apparatus are also disclosed.

### CROSS-REFERENCE TO RELATED APPLICATIONS

This application claims the benefit of U.S. Provisional Application No. 60/418,398, filed Oct. 15, 2002, the entire disclosure of which is herein incorporated by reference.

### TECHNICAL FIELD

This invention relates generally to a pressure management apparatus, and more particularly, to a pressure management apparatus adapted to facilitate selective venting between a tank interior and the surrounding environment at predetermined pressure differentials.

### BACKGROUND OF THE INVENTION

Service stations typically employ underground storage tanks to store fuel or other chemicals to be dispensed by an above ground dispensing station. Underground storage tanks and associated piping pose potential environmental concerns. It is desirable to maintain the structural integrity of the tank to prevent leakage of fuel and/or other chemicals from the tank to the surrounding environment. Moreover, the tank must include a sufficient closure to minimize or prevent loss of fuel or chemical vapors from the tank while permitting selective access to the interior of the tank. An airtight removable closure may minimize or prevent vapor loss but can result in damage to the tank if pressure differentials are permitted to develop between the tank interior and the surrounding environment.

It is known in the art to provide a removable closure that is intended to minimize vapor loss while protecting against over pressurization and under pressurization. For example, U.S. Pat. No. 2,088,226 to Arvintz discloses a combined plug and valve device for use in connection with vent pipes or filling pipes of a gasoline tank. Arvintz further discloses a cup-shaped strainer device for use with the combined plug and valve device. Arvintz, however, fails to adequately provide a user-friendly pressure management apparatus that can function under strict environmental regulations imposed by many jurisdictions.

Due to increasingly strict environmental regulations, there is a continuing need for pressure management apparatus adapted to minimize release of vapors from the interior of a storage tank without damaging the tank due to overpressurization or underpressurization.

### SUMMARY OF THE INVENTION

Accordingly, it is an object of the present invention to obviate problems and shortcomings of conventional and previously available pressure management apparatus. More particularly, it is an object of the present invention to provide a pressure management apparatus adapted to minimize vapor loss from the interior of a storage tank.

In accordance with one aspect of the present invention, a pressure management apparatus for coupling to an end of a vent pipe of a storage tank is provided. The pressure management apparatus includes a housing with an interior and a connector configured for coupling to an end of a vent pipe. A pressure valve is further provided and located at least partially within the interior of the housing. The pressure management apparatus also includes a removable filter with a portion configured to be selectively securely held between a portion of the housing and a portion of a vent pipe in use. The filter is adapted to minimize and/or prevent debris from traveling from an interior of a storage tank to the interior of the housing. The apparatus is configured such that, in use, disengaging the housing from a vent pipe releases the filter to permit removal of the filter from components of the pressure management apparatus.

In accordance with another aspect of the present invention, a pressure management apparatus is provided that includes a housing with an interior and a connector configured for coupling to an end of a vent pipe. The pressure management apparatus also includes a pressure valve located at least partially within the interior of the housing. The pressure valve has a high pressure valve portion and a low pressure valve portion. A high pressure valve seal is arranged between an area of the high pressure valve portion and an area of the housing. A low pressure valve seal is also arranged between an area of the low pressure valve portion and another area of the high pressure valve portion. At least one of the low pressure valve seal and the high pressure valve seal are formed from a pliable closed-cell material. The high pressure valve portion is configured to release fluid from an interior of a storage tank to the surrounding environment when the pressure within an interior of a storage tank rises above a predetermined level. In addition, the lower pressure valve portion is configured to admit fluid from the surrounding environment to an interior of a storage tank when the pressure within an interior of a storage tank drops below a predetermined pressure.

In accordance with still further aspects of the present invention, a pressure management apparatus is provided that includes an adapter configured for coupling to an end of a vent pipe and a housing including an interior and a connector removably engaged with the adapter. The pressure management apparatus includes a pressure valve with a high pressure valve portion and a low pressure valve portion, wherein the pressure valve is located at least partially within the interior of the housing. A high pressure valve seal is arranged between an area of the high pressure valve portion and an area of the housing. A low pressure valve seal is also arranged between an area of the low pressure valve portion and another area of the high pressure valve portion. The low pressure valve seal and high pressure valve seal are each formed from a pliable closed-cell epichlorohydrin. The high pressure valve portion is configured to release fluid from an interior of a storage tank to the surrounding environment when the pressure within an interior of a storage tank rises above a predetermined level. In addition, the lower pressure valve portion is configured to admit fluid from the surrounding environment to an interior of a storage tank when the pressure within an interior of a storage tank drops to a predetermined pressure. The pressure management apparatus further includes a removable filter including a portion configured to be selectively securely held between a portion of the adapter and a portion of the housing to restrain movement of the filter with respect to the housing and the adapter in use. The filter is adapted to minimize and/or prevent debris from traveling from an interior of a storage tank to the interior of the housing. In use, disengaging the connector of the housing from the adapter releases the filter to permit removal of the filter from components of the pressure management apparatus.

In accordance with additional aspects of the present invention, methods of providing a pressure management apparatus are disclosed. In on particular aspect of the present invention, disclosed herein is a method of providing a pressure management apparatus with an adapter configured for coupling to an end of a vent pipe. The pressure management apparatus includes a housing with an interior and a connector removably engaged with the adapter. A pressure valve is located at least partially within the interior of the housing. A removable filter is also provided with a portion trapped between a portion of the adapter and a portion of the housing to restrain movement of the filter with respect to the housing and the adapter. The method includes the steps of disengaging the connector of the housing from the adapter to release the filter, removing the filter from an area of the pressure management apparatus and inserting a new filter into the area of the pressure management apparatus. The method still further includes the step of re-engaging the connector of the housing to the adapter such that a portion of the new filter is trapped between a portion of the adapter and a portion of the housing to restrain movement of the new filter with respect to the housing and the adapter.

In accordance with further aspects of the present invention, disclosed herein are methods of providing a pressure management apparatus with a housing including an interior and a connector removably engaged with an end of a vent pipe. A pressure valve is located at least partially within the interior of the housing and a removable filter is provided with a portion trapped between a portion of the vent pipe and a portion of the housing to restrain movement of the filter with respect to the housing and the vent pipe. The method includes the steps of disengaging the connector of the housing from the vent pipe to release the filter, removing the filter from an area, and inserting a new filter into the area. The method further includes the step of re-engaging the connector of the housing with the vent pipe such that a portion of the new filter is trapped between a portion of the vent pipe and a portion of the housing to restrain movement of the new filter with respect to the housing and the vent pipe.

In accordance with still further aspects of the present invention, disclosed herein are methods of providing a pressure management apparatus with an adapter configured for coupling to an end of a vent pipe, a housing including an interior and a connector removably engaged with the adapter, and a pressure valve located at least partially within the interior of the housing. A removable filter is provided with a portion trapped between a portion of the adapter and a portion of the housing to restrain movement of the filter with respect to the housing and the adapter. The method comprises the steps of disengaging the connector of the housing from the adapter to release the filter and cleaning the filter. The method further comprises the steps of re-engaging the connector of the housing to the adapter such that a portion of the filter is trapped between a portion of the adapter and a portion of the housing to restrain movement of the filter with respect to the housing and the adapter.

In accordance with yet additional aspects of the present invention, disclosed herein are methods of providing a pressure management apparatus including a housing with an interior and a connector removably engaged with an end of a vent pipe. A pressure valve is located at least partially within the interior of the housing. A removable filter is provided with a portion trapped between a portion of the vent pipe and a portion of the housing to restrain movement of the filter with respect to the housing and the vent pipe. The method comprises the steps of disengaging the connector of the housing from the vent pipe to release the filter, cleaning the filter, and re-engaging the connector of the housing with the vent pipe such that a portion of the filter is trapped between a portion of the vent pipe and a portion of the housing to restrain movement of the filter with respect to the housing and the vent pipe.

Still other objects and advantages of the present invention will become apparent to those skilled in the art from the following description wherein there are shown and described alternative exemplary embodiments of this invention. As will be realized, the invention is capable of other different, obvious aspects and embodiments, all without departing from the invention. Accordingly, the drawings and descriptions should be regarded as illustrative in nature and not as restrictive.

### BRIEF DESCRIPTION OF THE DRAWINGS

While the specification concludes with claims particularly pointing out and distinctly claiming the present invention, it is believed the same will be better understood from the following description taken in conjunction with the accompanying drawings in which:

FIG. 1 is a perspective view of one exemplary pressure management apparatus coupled to an end of a vent pipe of a storage tank;

FIG. 2 is a top plan view of the pressure management apparatus of FIG. 1;

FIG. 3 is a sectional view of the pressure management apparatus along line 3-3 of FIG. 2;

FIG. 4 is a sectional view of the pressure management apparatus along line 4-4 of FIG. 2;

FIG. 4A is a sectional view similar to FIG. 4 except that a connector of the pressure management apparatus is coupled to an end of a vent pipe without the use of an adapter; and

FIG. 5 is a partial sectional schematic view of an underground storage tank arrangement with a vent pipe having a pressure management apparatus installed thereon in accordance with exemplary embodiments of the present invention.

### DETAILED DESCRIPTION OF EXEMPLARY EMBODIMENTS

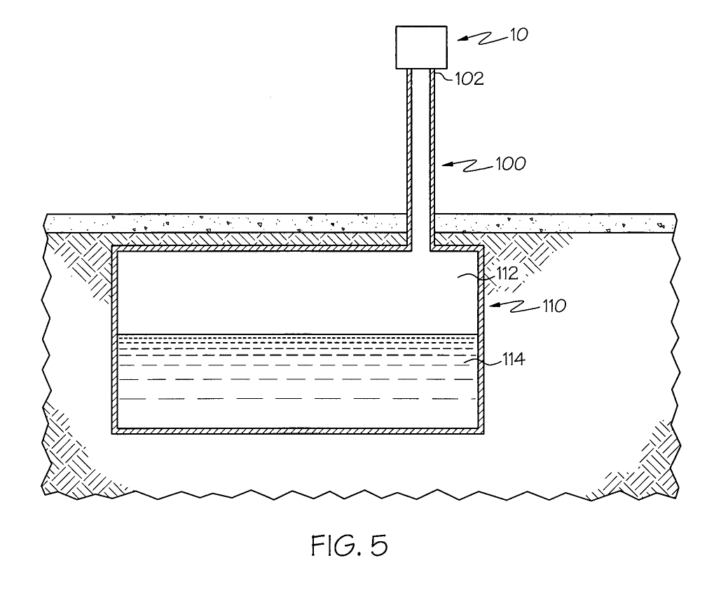

Turning now to the drawings in detail, wherein like numbers indicate the same or corresponding elements throughout the views, FIG. 5 depicts an exemplary storage tank 110 including liquid 114, such as hydrocarbon fuel, stored in an interior 112 of the storage tank 110. While the storage tank 110 is illustrated as an example of an underground arrangement, it should be understood that the present invention is equally applicable to all varieties of storage tank applications, both above and below ground. A vent pipe 100 can also be included for communication between the storage tank interior 112 and the surrounding environment. An exemplary pressure management apparatus 10 can be coupled to an end 102 of the vent pipe 100 to assist in managing the pressure of the storage tank interior 112.

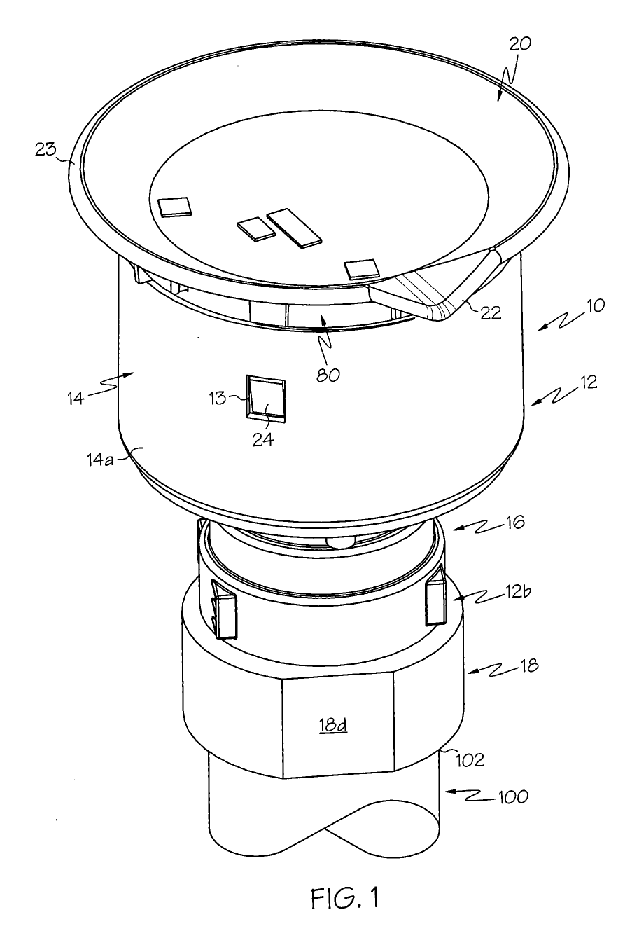

FIG. 1 illustrates a partial perspective view of an exemplary pressure management apparatus 10 coupled to an end 102 of a vent pipe 100. The pressure management apparatus 10 includes a housing 12, for example, with an upper housing 14 and a lower housing 16. As illustrated in the exemplary embodiment of FIGS. 1-4, the upper and lower housings can be formed separately and fastened together in a conventional manner. Forming the housing as separate members may simplify injection molds and also permit attachment of additional components of the apparatus between the upper and lower housing as described herein. In alternative embodiments, the housing might be formed as a single piece, wherein the functionality of the upper and lower housings are incorporated in a single, integrally-formed piece. Forming the housing as a single, integrally-formed piece may reduce assembly steps and therefore reduce manufacturing costs.

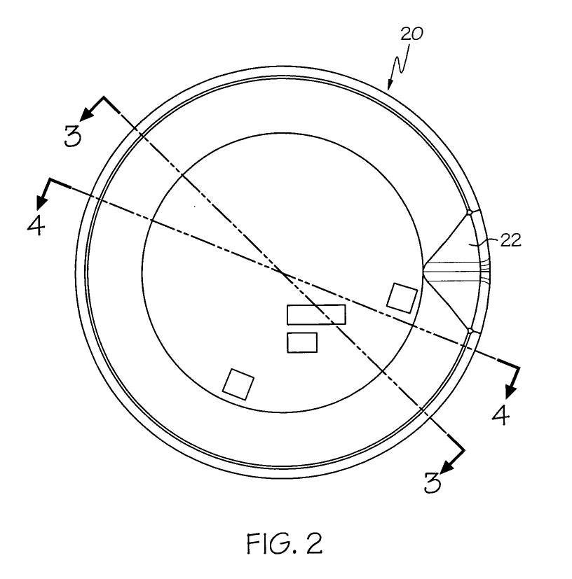

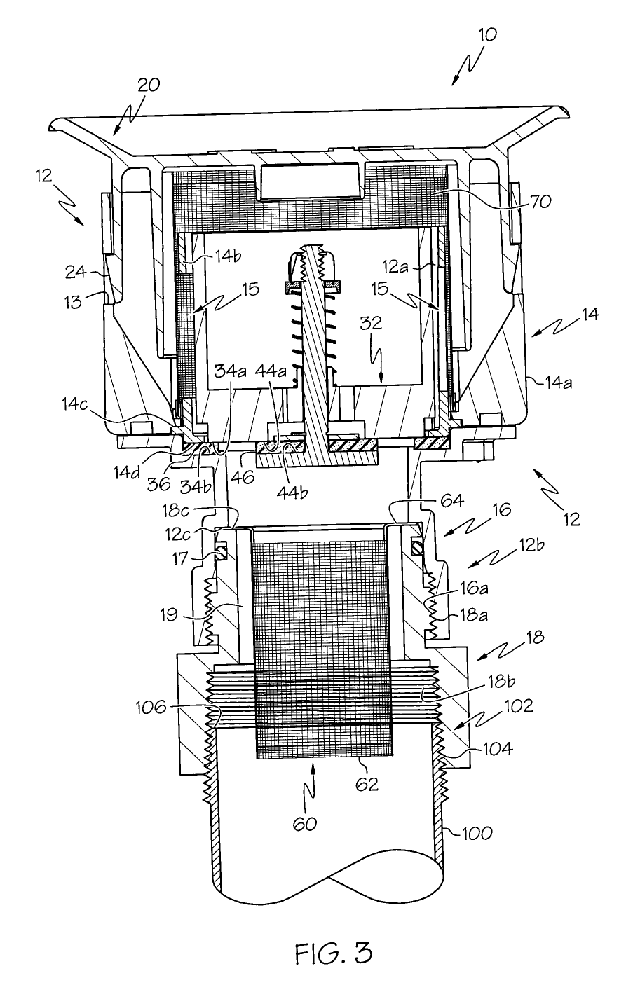

As further illustrated in FIG. 1, the pressure management apparatus 10 may include an optional lid 20 that can be removably connected to the housing 12. For example, as best seen in FIG. 3, the lid 20 may be provided with a latch 24 for selective engagement with an opening 13 defined in an outer portion 14a of the housing 12. The lid 20 may be provided to minimize and/or prevent exposure of an interior 12a of the housing 12 to adverse weather conditions and/or contamination with debris from the surrounding environment. The lid 20, if provided, may further include a spout 22 and raised rim 23 to facilitate control of condensation that may collect on the upper surface of the lid 20. As depicted in the top plan view of FIG. 2, the spout 22 may be arranged at a radial location to direct condensed fluid radially away from the pressure management apparatus 10 and/or the storage tank 110 positioned generally below the pressure management apparatus 10. Although a single spout 22 is illustrated, it should be understood that spouts or fluid controllers of alternate designs and/or a plurality of spouts, may be radially arranged about the circumference of the lid 20.

As further best illustrated in FIGS. 1, 3 and 4, exemplary embodiments of the pressure management apparatus 10 may include an optional adapter 18 to assist in coupling the pressure management apparatus to an end 102 of a vent pipe 100. For example, as best shown in FIGS. 1 and 3, the optional adapter 18 can be removably engaged with a connector 12b of the housing 12, and coupled to an end 102 of the vent pipe 100. In one exemplary embodiment, the adapter 18 includes threads (e.g., external threads 18a) for coupling with corresponding threads (e.g., internal threads 16a) of the connector 12b. As shown in FIG. 1, the outer surface of the adapter 18 may include a tool surface 18d, such as a flat portion to allow gripping of the adapter 18 by a torquing tool. For example, the tool surface 18d may include an opposed pair of flat surfaces (one of the surfaces being shown in FIG. 1) to allow gripping by a wrench. Although not shown, it is understood that the outer surface of the adapter 18 may comprise hexagonal, octagonal, or other shapes to provide a plurality of gripping surfaces, such as opposed pairs of tool surfaces.

The adapter 18 may further include additional threads, such as internal threads 18b adapted to be coupled to external threads 104 on the end 102 of the vent pipe 100. The interior and exterior threads are exemplary in nature and other mechanical arrangements may be used to provide for removable engagement between the pressure management apparatus and vent pipe such as a clamp arrangement, set screw, adhesive or other removable engagement arrangement. As further illustrated in FIG. 3, the adapter 18, if provided, may include a seal 17, such as a rubber O-ring, to facilitate a substantially fluid tight connection between the housing 12 and the adapter 18.

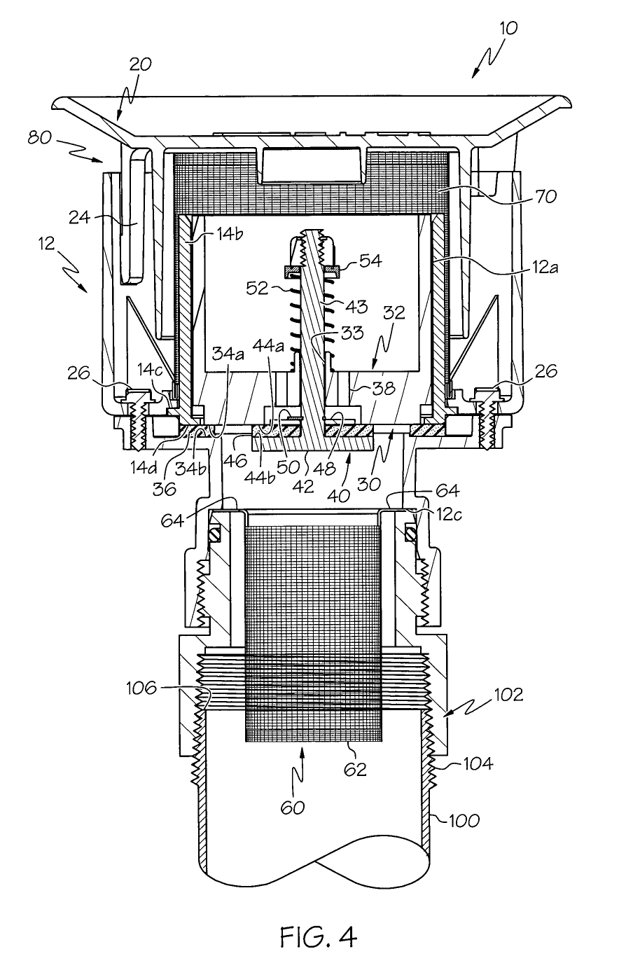

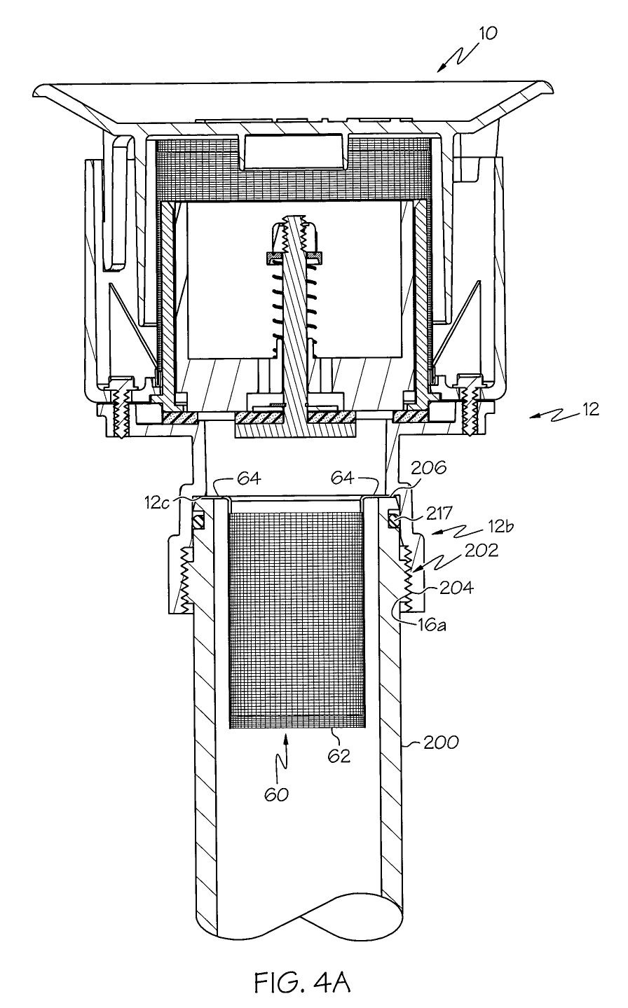

As described above, the connector 12b can be configured for coupling to the end 102 of the vent pipe 100 by use of the adapter 18. Providing an adapter may be desirable to create an extension for at least partially shrouding a removable filter 60. As shown, the adapter 18 protects the filter 60 by permitting extension of the filter 60 at least partially into an interior 19 of the adapter 18. The adapter 18 may also allow selective removal of the filter 60 and the housing 12 together as a single unit while protecting the filter 60 from damage. FIG. 4A depicts the connector 12b being configured for coupling to an end 202 of an alternative vent pipe 200 without the use of an adapter. Rather the connector 12b is configured for direct coupling to the end 202 of the vent pipe 200. As shown in FIG. 4A, interior threads 16a of the connector 12b match the exterior threads 204 on the end 202 of the vent pipe 200. As further shown, the end 202 of the vent pipe 200 may be provided with a seal 217, such as a rubber O-ring, to facilitate a substantially fluid tight connection between the housing 12 and the vent pipe 200.

In alternative embodiments, the pressure management apparatus may be simplified by elimination of the adapter, wherein the filter may be positioned adjacent the end of the vent pipe with the connector of the housing being engaged with the threads of the end of the vent pipe to secure the filter in place. In still further embodiments, the connector may be adapted for alternative use with or without an adapter to allow various configurations to be selected depending on the preferences of the consumer.

Turning to FIG. 4, the pressure management apparatus 10 is further illustrated as including a pressure valve 30 located at least partially within the interior 12a of the housing 12. The pressure valve can include a high pressure valve portion 32 and a low pressure valve portion 40, wherein the high pressure valve portion 32 can be configured to release fluid from the interior 112 of the storage tank 110 to the surrounding environment when the pressure within the tank interior 112 rises above a predetermined pressure. Similarly, the low pressure valve portion 40 can be configured to admit fluid from the surrounding environment to the tank interior 112 of the storage tank 110 when the pressure within the tank interior 112 drops below a predetermined pressure.

As further illustrated in FIGS. 3 and 4, the pressure valve 30 can also include a high pressure valve seal 36 arranged between an area 34a of the high pressure valve portion 32 and an area 34b of the housing 12. In addition, a low pressure valve seal 46 can be arranged between an area 44b of the low pressure valve portion 40 and another area 44a of the high pressure valve portion 32. The high pressure valve seal 36 and low pressure valve seal 46 can be trapped or positioned in place based on the shape and arrangement of the remaining components of the pressure management apparatus 10. In further embodiments, the high pressure valve seal 36 and low pressure valve seal 46 can be attached with one or more fastening arrangements. For example, the seals may be attached with an adhesive and/or the seal can be mounted in place. As shown in the example of FIG. 4, the low pressure valve seal 46 can be connected to a plug 42 of the low pressure valve portion 40 with a washer 48 held in place by a circlip 50 attached to a shank 43 of the low pressure valve portion 40.

As further illustrated in FIG. 4, the plug 42 of the low pressure valve portion 40 may be biased against an underside of the high pressure valve portion 32 with a biasing member 52, such as a compression spring. A stop member 54 can be connected to the shank 43 to provide an abutment area for the biasing member 52.

The stop member 54 may be adjustable with respect to the shank 43 to permit pre-setting of the initial compression of the biasing member, and therefore, an initial biasing force of the plug 42 against the underside of the high pressure valve portion 32. For example, by adjusting the stop member 54 to increase the biasing member compression, the biasing force applied by the biasing member 52 to the low pressure valve portion 40 may be increased. In this way, a predetermined base or lowest pressure necessary to break the seal between the area 44a of the high pressure valve portion 32 and the low pressure valve seal 46 to admit fluid from the surrounding environment to an interior of the storage tank can be “dialed” into the apparatus. The stop member 54 may comprise a nut that can be rotatably adjustable on a threaded portion of the shank 43. Although not shown, a second nut may also be provided to function as a lock nut, thereby preventing inadvertent adjustment of the stop member 54 once it is adjusted to the desired pressure.

In this example, the weight of the high pressure valve portion 32 provides a similar bias against the high pressure valve seal 36 to facilitate the required sealing between the housing 12 and the high pressure valve portion 32. Adjusting the weight of the high pressure valve seal 36 may similarly permit different initial biasing forces of the high pressure valve portion 32 against the high pressure valve seal 36. For example, increasing the weight of the high pressure valve portion 32 may cause a higher pressure against the high pressure valve seal 36. Provisions may be incorporated to allowing the weight to be adjusted. For example, weight plugs may be attached to the high pressure valve portion 32 to allow adjustment of the weight. In addition, or alternatively, a biasing member can be provided to administer a force to the high pressure valve portion 32. Therefore, by adjusting the weight or biasing of the high pressure valve portion, a predetermined base or highest pressure necessary to break the seal between the area 34a of the high pressure valve portion 32 and the high pressure valve seal 36 to release fluid from an interior of the storage tank to the surrounding environment can be entered into the apparatus.

At least one of the low pressure valve seal 46 and the high pressure valve seal 36 can be formed from a pliable material in order to minimize the effect of debris on the integrity of the fluid-tight seal arrangement. A fluid tight seal arrangement is desirable to minimize and/or prevent release of fluid vapor from the interior 112 of the storage tank 110. If debris is introduced at such a seal, the pliable material may deform to mold in response to the debris, thereby minimizing and/or preventing any effect the debris may otherwise have on the integrity of the fluid-tight sealing arrangement. The pliable material can be selected from a variety of materials including a polymeric material, thermoplastic materials, elastomeric materials such as rubber, and/or closed-cell materials such as a foam. A closed-cell material may be desirable to provide a pliable material that substantially prevents fluid communication therethrough. Moreover, the seals may be cut from the substantially closed-cell material such that a series of cavities (i.e., partially closed cells) are located adjacent to the surface where the material was severed. In use, these cavities may receive fine particulate debris that can actually further enhance the fluid-tight seal between components of the pressure management apparatus. Meanwhile, the filters are effective to prevent introduction of larger debris that may interfere with the sealing integrity. In one exemplary embodiment, the closed-cell material comprises epichlorohydrin. Closed-cell epichlorohydrin, for example, may provide the necessary pliability without fluid communication therethrough and can have severed edges to encourage retention of fine particulate debris. Moreover, epichlorohydrin can provide excellent durability and extend the seal life due to its ability to withstand the harsh operating conditions encountered by a pressure management apparatus.

As also seen in FIGS. 3 and 4, the pressure management apparatus 10 may further include an inner cage 14b to provide a vertical travel path for the high pressure valve portion 32. The inner cage 14b may have a lip 14c to assist in mounting the inner cage 14b to the housing 12. For example, the lip 14c may be effectively trapped between the upper housing 14 and lower housing 16 prior to fastening the upper and lower housing together with fasteners 26 for example. As further illustrated in FIGS. 3 and 4, a lower protrusion 14d may be provided to trap the high pressure valve seal 36 with the housing 12. Trapping the high pressure valve seal 36 in this manner may avoid requiring an adhesive or other securement to attach the seal to the housing. It is contemplated, however, that the high pressure valve seal 36 can be adhered to the housing 12 with an adhesive as well as being pressed against the housing by the lower protrusion 14d of the inner cage 14b.

As best seen in FIG. 3, the inner cage 14b may further include one or more opening(s) 15 adapted to facilitate fluid release from the pressure management apparatus 10. An environmental-side filter 70 may be provided to minimize and/or prevent debris from traveling to the interior 12a of the housing 12 from the surrounding environment. Similarly, a tank-side removable filter 60 may be provided to minimize and/or prevent debris from traveling from an interior 112 of a storage tank 110 to the interior 12a of the housing 12. Exemplary filters may be formed from a mesh material, such as a wire mesh or appropriate gauge or pore size. However, it is understood that other pressure pervious materials and/or arrangements may be used for the filters including a fabric mesh, fibrous material, or the like. Minimizing and/or preventing debris from traveling into the interior of 12a of the housing 12 can be beneficial to reduce introduction of debris at the sealing areas, thereby improving the sealing characteristics of the pressure management apparatus.

Each filter, if provided, can be removable in nature. In addition, one or more of the filters may be selectively secured in place. For instance, the tank-side filter may be provided as a removable filter 60 with a filter portion 62 (e.g., wire mesh) and a portion 64 adapted to facilitate selective securement.

In exemplary embodiments, as shown in FIGS. 1, 3, 4 and 4A, the removable filter 60 may include a portion 64 configured to be selectively securely held between a portion of the housing and a portion of the vent pipe in use. For example, as best shown in FIGS. 1, 3 and 4, the portion 64 of the removable filter 60 may be selectively secured between the portion 12c of the housing 12 and a portion 118c of the adapter 18. In alternative embodiments without an adapter (e.g., see FIG. 4A), the portion 64 of the removable filter 60 can be selectively secured between the portion 12c of the housing 12 and the portion 206 of the vent pipe 200.

Components of the pressure management apparatus (e.g., the upper housing 14, lower housing 16, lid 20, inner cage 14b and optional adapter 18) may optionally be formed from a thermoplastic resin with an injection molding process. In one example, the components may be formed from Delrin material. Other processes and materials may also be used. For example, components of the pressure management apparatus may comprise aluminum, brass, stainless steel and/or other metal materials that can withstand the operating conditions of the pressure management apparatus.

Exemplary methods of fabricating the pressure management apparatus 10 will now be described. In the illustrative embodiments, the high pressure valve seal 36 can be positioned in a groove formed in the lower housing 16. The inner cage 14b may then positioned with respect to the lower housing 16 such that the lower protrusion 14d abuts against an upper surface of the high pressure valve seal 36. The upper housing 14 can then be placed against the lip 14c of the inner cage 14b. The upper housing 14 may then be pressed downward such that the lower protrusion 14d presses against the upper surface of the high pressure valve seal 36 to restrain the high pressure valve seal 36 in place. Next, the upper housing 14 can be fastened to the lower housing 16 with a plurality of fasteners 26 to form a unit comprising the upper housing 14, lower housing 16, inner cage 14b and high pressure valve seal 36.

Next, an exemplary procedure for assembly the pressure valve 30 is described. An optional adhesive layer is first applied to the area 44b of the lower pressure valve portion 40. An annular center cut out of the low pressure valve seal 46 is placed over the shank 43 and slid down such that the low pressure valve 46 seal abuts the adhesive layer adjacent the area 44b of the low pressure valve portion 40. The washer 48, if provided, is then placed over the shank 43 and slid down in abutment with the lower pressure valve seal 46. Next, a circlip 50 can be snapped into place to lock the low pressure valve seal 46 with respect to the plug 42. The shank 43 is then slid through an opening 33 of the high pressure valve portion 32. A biasing member 52 (e.g., compression spring) may also be inserted over the shank 43 and then a stop member 54, such as a nut, can be installed on the shank 43.

The pressure valve 30 is then placed within the inner cage 14b such that it is at least partially within the interior 12a of the housing 12. The weight of the valve 30 may cause the valve 30 to move downwardly within the inner cage 14b until the area 34a of the high pressure valve portion engages the high pressure valve seal 36. The environmental-side filter 70 may then placed over the inner cage 14b to minimize and/or prevent debris from traveling to the interior 12a of the housing 12 from the surrounding environment. The lid 20 can then be placed over the upper housing 14 and arranged such that the latches 24 engage the openings 13 defined in an outer portion 14a of the upper housing 14.

The O-ring 17 can also be installed in a groove of the adapter 18 and the internal threads 18b of the adapter 18 can be coupled with the external threads 104 on the end 102 of a vent pipe 100. At least a portion of the removable filter 60 may be inserted into an interior 19 of the adapter 18 until the portion 64 of the filter abuts the portion 18c of the adapter 18. Next, the connector 12b of the housing 12 may be coupled to the end 102 of the vent pipe 100 with the use of the adapter 18. In particular, the internal threads 16a of the connector 12b may be coupled with external threads 18a of the adapter to couple the adapter 18 with the housing 12, thereby selectively securely holding the removable filter 60 between the portion 12c of the housing 12 and the portion 18c of the adapter 18. Once coupled, the O-ring 17 facilitates a vapor seal between the adapter 18 and the lower housing 16.

In an alternative embodiment (e.g., see FIG. 4A), the removable filter 60 and connector 12b may be sized for cooperation with the vent pipe 200 without the use of an adapter. In this embodiment, the filter can be inserted into the vent pipe 200 until an upper portion 64 of the filter 60 rests against the portion 206 of the vent pipe 200. Next, the interior threads 16a of the connector 12b can be coupled with the exterior threads 204 of the end 202 of the vent pipe 200 to selectively securely hold the removable filter 60 between a portion 12c of the housing and the portion 206 of the vent pipe 200.

Once the pressure management apparatus 10 is installed, vapor loss from the storage tank 110 is minimized while protecting the tank 110 from damage due to over or under pressurization. If pressure within the interior 112 of the storage tank 110 rises above a predetermined pressure, the high pressure valve portion 32 temporarily rises to break the seal between the area 34a of the high pressure valve portion 32 and the high pressure valve seal 36. Pressurized gas within the tank interior 112 can then travel up through the vent pipe 100, through the filter portion 62, through openings 15 (see FIG. 3) in the inner cage 14b and out one or more vent openings 80 defined between the lid 20 and the housing 12. After the pressure within the interior 112 of the storage tank 110 drops sufficiently, the high pressure valve portion 32 drops again to reestablish the seal between the area 34a of the high pressure valve portion 32 and the high pressure valve seal 36 to minimize and/or prevent further release of gas from within the tank interior 112. The removable filter 60 minimizes and/or prevents debris from traveling from the interior 112 of the storage tank 110 to the interior 12a of the housing 12. Accordingly, the removable filter 60 enhances the functionality of the high pressure valve seal 36 and the low pressure valve seal 46.

If pressure within the interior 112 of the storage tank 110 drops below a predetermined value, the plug 42 of the low pressure valve portion 40 temporarily shifts downwardly with respect to the high pressure valve portion 32, against the force of the biasing member 52, thereby breaking the seal between the area 44a of the high pressure valve portion 32 and the low pressure valve seal 46. Fluid from the surrounding environment may then admitted through the vent openings 80, through the environmental-side filter 70, through channels 38 defined in the high pressure valve portion 32 and through the vent pipe 100 to the interior 112 of the storage tank 110. After the pressure within the interior 112 of the storage tank 110 rises sufficiently, the plug 42 shifts upwardly with respect to the high pressure valve portion 32, under the influence of the biasing member 52, to reestablish the seal between the area 44a of the high pressure valve portion 32 and the low pressure valve seal 46 to minimize and/or prevent further release of gas from within the tank interior 112. The environmental-side filter 70 minimizes and/or prevents debris from traveling to the interior 112 of the storage tank 110 from the surrounding environment. Accordingly, the environmental-side filter 70 enhances the functionality of the high pressure valve seal 36 and the low pressure valve seal 46.

Methods of providing a pressure management apparatus 10 include providing the adapter 18 configured for coupling to the end 102 of the vent pipe 100. The connector 12b of the housing 12 can be removably engaged with the adapter 18. The pressure valve 30 can also be located at least partially within the interior 12a of the housing 12. The removable filter 60 includes a portion 64 trapped between a portion 18c of the adapter 18 and a portion 12c of the housing 12 to restrain movement of the filter 60 with respect to the housing 12 and the adapter 18. The exemplary methods include the steps of disengaging the connector 12b of the housing 12 from the adapter 18 to release the filter 60. The filter 60 may then removed from an area of the pressure management apparatus (e.g., the interior 19 of the adapter 18). A new filter can then inserted into the area (e.g., the interior 19 of the adapter 18) and the connector 12b may then be re-engaged to the adapter 18 such that a portion 64 of the new filter may then be trapped between the portion 18c of the adapter 18 and the portion 12c of the housing 12 to restrain movement of the new filter with respect to the housing 12 and the adapter 18.

Additional methods of providing a pressure management apparatus 10 include providing the housing 12 with the connector 12b removably engaged with the end 202 of the vent pipe 200. The pressure valve 30 may be located at least partially within the interior 12a of the housing 12. The removable filter 60 can include a portion 64 trapped between a portion 206 of the vent pipe 200 and a portion 12c of the housing 12 to restrain movement of the filter 60 with respect to the housing 12 and the vent pipe 200. The methods may comprise the steps of disengaging the connector 12b of the housing 12 from the vent pipe 200 to release the filter 60. The filter 60 may then removed from an area (e.g., the interior of the vent pipe) and a new filter may be inserted into the area (e.g., the interior of the vent pipe). The connector 12b of the housing 12 may then be re-engaged with the vent pipe 200 such that a portion of the new filter may then be trapped between a portion 206 of the vent pipe 200 and a portion 12c of the housing 12 to restrain movement of the new filter with respect to the housing 12 and the vent pipe 200.

As alternatives to the methods described in the two paragraphs immediately above, the original filter can be simply cleaned in place prior to re-engaging the connector rather than removing the filter and inserting a new filter.

The foregoing description of the various examples and embodiments of the invention has been presented for the purposes of illustration and description. It is not intended to be exhaustive or to limit the invention to the precise form disclosed. Many alternatives, modifications and variations will be apparent to those skilled in the art. Accordingly, this invention is intended to embrace all alternatives, modifications and variations that have been discussed herein, and others that fall within the spirit and broad scope of the claims.

What is claimed is:

1. A pressure management apparatus for coupling to an end of a vent pipe of a storage tank comprising:
a) a housing including an interior and a connector configured for coupling to an end of a vent pipe;
b) a pressure valve located at least partially within the interior of the housing; and
c) a removable filter including a portion configured to be selectively securely held between a portion of the housing and a portion of a vent pipe in use, the filter being adapted to minimize and/or prevent debris from traveling from an interior of a storage tank to the interior of the housing, and wherein said apparatus is configured such that, in use, disengaging the housing from a vent pipe releases the filter to permit removal of the filter from components of the pressure management apparatus.

2. The pressure management apparatus of claim 1, including an additional filter adapted to minimize and/or prevent debris from traveling to the interior of the housing from the surrounding environment.

3. The pressure management apparatus of claim 1, further comprising an adapter removably engaged with the connector and configured for coupling to an end of a vent pipe.

4. The pressure management apparatus of claim 3, wherein the portion of the filter is trapped between a portion of the adapter and the portion of the housing, and wherein disengaging the housing from the adapter releases the filter to permit removal of the filter from components of the pressure management apparatus.

5. The pressure management apparatus of claim 3, wherein the adapter includes an interior and wherein the filter extends at least partially into the interior of the adapter.

6. The pressure management apparatus of claim 3, wherein the adapter comprises threads for coupling to an end of a vent pipe and additional threads for removable engagement with the connector of the housing.

7. The pressure management apparatus of claim 1, wherein the pressure valve includes a high pressure valve portion and a low pressure valve portion, wherein the high pressure valve portion is configured to release fluid from an interior of a storage tank to the surrounding environment when the pressure within an interior of a storage tank rises above a predetermined level and wherein the low pressure valve portion is configured to admit fluid from the surrounding environment to an interior of a storage tank when the pressure within an interior of a storage tank drops below a predetermined pressure.

8. The pressure management apparatus of claim 7, wherein a high pressure valve seal is arranged between an area of the high pressure valve portion and an area of the housing and a low pressure valve seal is arranged between an area of the low pressure valve portion and another area of the high pressure valve portion.

9. The pressure management apparatus of claim 8, wherein at least one of the low pressure valve seal and the high pressure valve seal are formed from a pliable material.

10. The pressure management apparatus of claim 9, wherein the pliable material comprises a polymeric material.

11. The pressure management apparatus of claim 9, wherein the pliable material comprises an elastomeric material.

12. The pressure management apparatus of claim 9, wherein the pliable material comprises closed-cell material.

13. The pressure management apparatus of claim 12, wherein the closed-cell material comprises foam.

14. The pressure management apparatus of claim 12, wherein the closedcell material comprises epichlorohydrin.

15. A pressure management apparatus for coupling to an end of a vent pipe of a storage tank comprising:
a) a housing including an interior and a connector configured for coupling to an end of a vent pipe; and
b) a pressure valve located at least partially within the interior of the housing and including a high pressure valve portion and a low pressure valve portion, a high pressure valve seal is arranged between an area of the high pressure valve portion and an area of the housing and a low pressure valve seal is arranged between an area of the low pressure valve portion and another area of the high pressure valve portion, at least one of the low pressure valve seal and the high pressure valve seal are formed from a pliable closed-cell material, wherein the high pressure valve portion is configured to release fluid from an interior of a storage tank to the surrounding environment when the pressure within an interior of a storage tank rises above a predetermined level and wherein the lower pressure valve portion is configured to admit fluid from the surrounding environment to an interior of a storage tank when the pressure within an interior of a storage tank drops below a predetermined pressure.

16. The pressure management apparatus of claim 15, including a filter adapted to minimize and/or prevent debris from traveling to the interior of the housing from the surrounding environment.

17. The pressure management apparatus of claim 15, including a removable filter including a portion configured to be selectively securely held between a portion of the housing and a portion of a vent pipe in use, the filter being adapted to minimize and/or prevent debris from traveling from an interior of a storage tank to the interior of the housing, and wherein, in use, disengaging the housing from a vent pipe releases the filter to permit removal of the filter from components of the pressure management apparatus.

18. The pressure management apparatus of claim 17, including an adapter removably engaged with the connector of the housing and configured for coupling to an end of a vent pipe

19. The pressure management apparatus of claim 18, wherein the portion of the filter is trapped between a portion of the adapter and the portion of the housing to restrain movement of the filter with respect to the housing and adapter, and wherein disengaging the housing from the adapter releases the filter to permit removal of the filter from components of the pressure management apparatus.

20. The pressure management apparatus of claim 18, wherein the adapter comprises threads for coupling to an end of a vent pipe and additional threads for removable engagement with the housing.

21. The pressure management apparatus of claim 18, wherein the adapter includes an interior and wherein the filter extends at least partially into the interior of the adapter.

22. The pressure management apparatus of claim 15, wherein the pliable closed-cell material comprises foam.

23. The pressure management apparatus of claim 15, wherein the pliable closed-cell material comprises a polymeric material.

24. The pressure management apparatus of claim 15, wherein the pliable closed-cell material comprises an elastomeric material.

25. The pressure management apparatus of claim 15, wherein the pliable closed-cell material comprises epichlorohydrin.

26. A pressure management apparatus for coupling to an end of a vent pipe comprising:
a) an adapter configured for coupling to an end of a vent pipe;
b) a housing including an interior and a connector removably engaged with the adapter;
c) a pressure valve located at least partially within the interior of the housing and including a high pressure valve portion and a low pressure valve portion, a high pressure valve seal is arranged between an area of the high pressure valve portion and an area of the housing and a low pressure valve seal is arranged between an area of the low pressure valve portion and another area of the high pressure valve portion, the low pressure valve seal and high pressure valve seal are each formed from a pliable closed-cell epichlorohydrin, wherein the high pressure valve portion is configured to release fluid from an interior of a storage tank to the surrounding environment when the pressure within an interior of a storage tank rises above a predetermined level and wherein the lower pressure valve portion is configured to admit fluid from the surrounding environment to an interior of a storage tank when the pressure within an interior of a storage tank drops to a predetermined pressure; and
d) a removable filter including a portion configured to be selectively securely held between a portion of the adapter and a portion of the housing to restrain movement of the filter with respect to the housing and the adapter in use, the filter being adapted to minimize and/or prevent debris from traveling from an interior of a storage tank to the interior of the housing, and wherein, in use, disengaging the connector of the housing from the adapter releases the filter to permit removal of the filter from components of the pressure management apparatus.

27. A method of providing a pressure management apparatus including an adapter configured for coupling to an end of a vent pipe, a housing including an interior and a connector removably engaged with the adapter, a pressure valve located at least partially within the interior of the housing, and a removable filter including a portion trapped between a portion of the adapter and a portion of the housing to restrain movement of the filter with respect to the housing and the adapter, the method comprising the steps of:
a) disengaging the connector of the housing from the adapter to release the filter;
b) removing the filter from an area of the pressure management apparatus;
c) inserting a new filter into the area of the pressure management apparatus; and
d) re-engaging the connector of the housing to the adapter such that a portion of the new filter is trapped between a portion of the adapter and a portion of the housing to restrain movement of the new filter with respect to the housing and the adapter.

28. A method of providing a pressure management apparatus comprising a housing including an interior and a connector removably engaged with an end of a vent pipe, a pressure valve located at least partially within the interior of the housing, and a removable filter including a portion trapped between a portion of the vent pipe and a portion of the housing to restrain movement of the filter with respect to the housing and the vent pipe, the method comprising the steps of:
a) disengaging the connector of the housing from the vent pipe to release the filter;
b) removing the filter from an area;
c) inserting a new filter into the area; and
d) re-engaging the connector of the housing with the vent pipe such that a portion of the new filter is trapped between a portion of the vent pipe and a portion of the housing to restrain movement of the new filter with respect to the housing and the vent pipe.

29. A method of providing a pressure management apparatus including an adapter configured for coupling to an end of a vent pipe, a housing including an interior and a connector removably engaged with the adapter, and a pressure valve located at least partially within the interior of the housing, and a removable filter including a portion trapped between a portion of the adapter and a portion of the housing to restrain movement of the filter with respect to the housing and the adapter, the method comprising the steps of:
a) disengaging the connector of the housing from the adapter to release the filter;
b) cleaning the filter; and
c) re-engaging the connector of the housing to the adapter such that a portion of the filter is trapped between a portion of the adapter and a portion of the housing to restrain movement of the filter with respect to the housing and the adapter.

30. A method of providing a pressure management apparatus comprising a housing including an interior and a connector removably engaged with an end of a vent pipe, a pressure valve located at least partially within the interior of the housing, and a removable filter including a portion trapped between a portion of the vent pipe and a portion of the housing to restrain movement of the filter with respect to the housing and the vent pipe, the method comprising the steps of:
a) disengaging the connector of the housing from the vent pipe to release the filter;
b) cleaning the filter; and
c) re-engaging the connector of the housing with the vent pipe such that a portion of the filter is trapped between a portion of the vent pipe and a portion of the housing to restrain movement of the filter with respect to the housing and the vent pipe.
